(19) United States
(12) Patent Application Publication
(10) Pub. No.: US 2026/0320824 A1
(43) Pub. Date: Oct. 15, 2026

(54) POSITION ESTIMATION DEVICE, WORK SUPPORT DEVICE, POSITION ESTIMATION PROGRAM AND WORK SUPPORT PROGRAM

(71) Applicant: Hitachi, Ltd., Tokyo (JP)

(72) Inventors: Yasutaka SERIZAWA, Tokyo (JP); Hisanori MATSUMOTO, Tokyo (JP)

(21) Appl. No.: 19/542,841

(22) Filed: Feb. 18, 2026

(30) Foreign Application Priority Data
Apr. 14, 2025 (JP) 2025-066216

(51) Int. Cl. G06T 7/73

(52) U.S. Cl. CPC G06T 7/74

(57) ABSTRACT

The position of the target is estimated by a data acquisition unit that acquires an production-site floor image captured by an imaging unit of a worker terminal worn by the target, a target area identification unit that identifies, based on the input data, area information of a target area range where the target is present, a three-dimensional space information identification unit that identifies, based on the area information, target area three-dimensional space information that is three-dimensional space information of the target area range, a field-of-view image extraction unit that extracts a field-of-view image virtually indicating a field of view of the target and corresponding to a point of view and a field-of-view direction of the target based on the area information, and a position estimation unit that calculates position information indicating the position of the target by comparing the field-of-view image with the captured production-site floor image.

### CLAIM OF PRIORITY

The present application claims priority from Japanese Patent Application JP 2025-066216 filed on Apr. 14, 2025, the content of which are hereby incorporated by references into this application.

### BACKGROUND OF THE INVENTION

The present invention relates to a technique for estimating a position of a target person or an object (hereinafter merely referred to as a target) and more specifically to a technique for estimating a position of a worker to support work.

Currently, the use of position information is expanding due to the growing application of map data and the proliferation of portable devices such as smartphones and wearable devices. For example, the position information can be used for work support, navigation and guidance systems including car navigation, control of movement of mobile objects, monitoring of the flow of people, and measures to prevent people from getting lost.

In these applications, improving the accuracy of the position information is required to provide appropriate services. In particular, indoors, it is difficult to use a global positioning system (GPS), and the accuracy of the position information is reduced compared to outdoors.

If the accuracy of the position information is reduced, it is difficult to provide appropriate position-related information. The position-related information includes the position information of a target person, a route and time to a destination, and work-related information including work support information.

As a technique for appropriately providing the work support information that is an example of position-related information, Japanese Unexamined Patent Application Publication No. 2016-181751 has been proposed. In Japanese Unexamined Patent Application Publication No. 2016-181751, details of on-site work and progress information are transmitted to a remote support person or a work support engineer using a wearable device, and the appropriate work support information is fed back to the on-site.

Specifically, Japanese Unexamined Patent Application Publication No. 2016-181751 discloses a work support wearable device that is included in “a remote work support system that includes the work support wearable device wearable by a worker and including a camera device and a motion sensor, and a work support terminal that is operated by a support person and connected to the wearable device and includes a display, the terminal including a unit that sequentially receives video data captured by the camera device and motion data acquired by the motion sensor in the wearable device, a unit that generates, based on the received video data and the received motion data, a single composite still image depicting a surrounding environment in a wide area, and a unit that displays, on the display, a mixed image in which the composite still image and a video made from the video data are aligned”.

### SUMMARY OF THE INVENTION

To achieve purposes in work, navigation, and the like, it is necessary to improve the accuracy of position estimation. To improve the accuracy, it is necessary to take into consideration of an environment, such as an area where a target is present. In particularly, in a case where a plurality of similar areas or a plurality of candidate targets are present, it is difficult to accurately estimate a position. Japanese Unexamined Patent Application Publication No. 2016-181751 has not addressed advanced position estimation that takes such an environment into account. An object of the present invention is to accurately estimate a position of a target.

To solve the above-described problems, according to an aspect of the present invention, a position estimation device that estimates a position of a target includes: a data acquisition unit that acquires an production-site floor image captured by a device worn by the target; a field-of-view image extraction unit that extracts a field-of-view image virtually indicating a field of view of the target and corresponding to field-of-view information of the target based on target area three-dimensional space information that is three-dimensional space information of a target area range where the target is present; and a position estimation unit that calculates the position information indicating the position of the target by comparing the field-of-view image with the captured production-site floor image.

According to another aspect of the present invention, a position estimation device that estimates a position of a target includes: a data acquisition unit that acquires an production-site floor image captured by a device worn by the target, and input data from the target; a target area identification unit that identifies, based on the input data, area information of a target area range where the target is present; a three-dimensional space information identification unit that identifies, based on the area information, the target area three-dimensional space information that is three-dimensional space information of the target area range; the field-of-view image extraction unit that extracts the field-of-view image virtually indicating a field of view of the target and corresponding to field-of-view information of the target based on the area information; and a position estimation unit that calculates the position information indicating the position of the target by comparing the field-of-view image with the captured production-site floor image.

In addition, the present invention includes a work support device that generates the work support information for the target based on the calculated position information. The present invention further includes a position estimation program that causes the position estimation device to function, and a storage medium storing the position estimation program. The present invention further includes a work support program that causes the work support device to function, and a storage medium storing the work support program.

According to the present invention, it is possible to accurately estimate a position.

### BRIEF DESCRIPTION OF THE DRAWINGS

FIG. 1 is a diagram schematically illustrating a production site according to an embodiment of the present invention.

FIG. 2 is a functional block diagram schematically illustrating a work support system according to the embodiment of the present invention.

FIG. 3 is a flowchart illustrating a procedure for a work support process according to the embodiment of the present invention.

FIG. 4A is a diagram illustrating an entire work support system and each device implementing a worker terminal according to a first embodiment.

FIG. 4B is a diagram illustrating an example of a position estimation device 1a according to the first embodiment.

FIG. 4C is a diagram illustrating an example of a work support information generation device 1b according to the first embodiment.

FIG. 5A is a flowchart illustrating a procedure for a work support process according to the first embodiment.

FIG. 5B is a flowchart illustrating a procedure for the work support process according to the first embodiment.

FIG. 6A is a diagram schematically illustrating a first specific example of a process of extracting target three-dimensional space information according to the first embodiment.

FIG. 6B is a diagram schematically illustrating a second specific example

of a process of extracting the target three-dimensional space information according to the first embodiment.

FIG. 7A is a diagram schematically illustrating a first specific example of a process of extracting a field-of-view image according to the first embodiment.

FIG. 7B is a diagram schematically illustrating a second specific example of a process of extracting the field-of-view image according to the first embodiment.

### DETAILED DESCRIPTION OF THE PREFERRED EMBODIMENTS

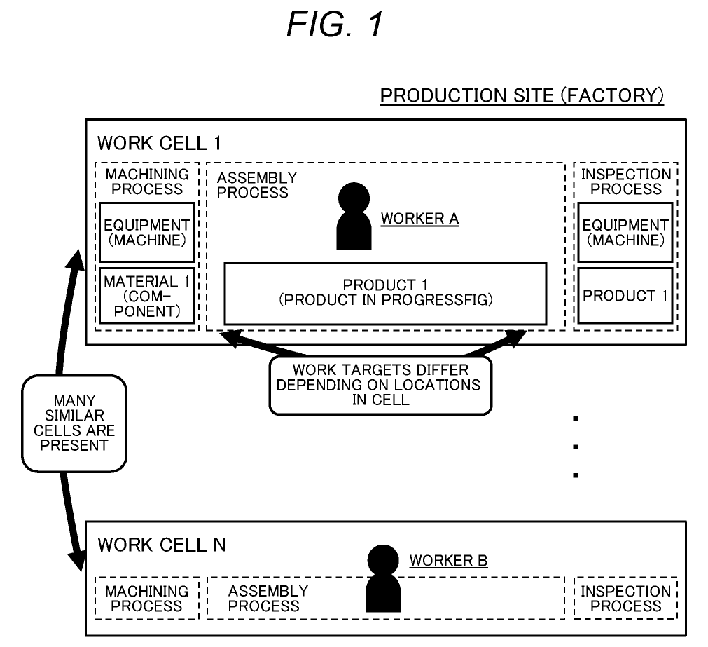

Hereinafter, an embodiment of the present invention will be described. In the present embodiment, the work support for a worker in a production site such as a factory is described as an example. FIG. 1 is a diagram schematically illustrating the production site according to the present embodiment.

In the present embodiment, the production site where a control device or a device for a railway vehicle is produced is a target site. This production site is also referred to as a production line. In the production site, the work support, such as an advice, is performed for the worker. In particular, when an unforeseen event occurs in the production site, the work support is performed by presenting a method for handling the foreseen event or the like to the worker.

However, as illustrated in FIG. 1, a plurality of work cells (work cells 1 to N) are present in the production site. Therefore, many similar cells are present, it is difficult to identify a worker who has encountered the unforeseen event, and it is difficult to estimate the position of the worker. For example, it may be difficult to determine whether the unforeseen event has occurred in the work cell 1 or the work cell N. In this case, it is difficult to determine whether to perform the work support for a worker A or a worker B.

As a result, despite the worker A has encountered the unforeseen event, it is erroneously recognized that the worker B has encountered the unforeseen event. In this case, the position of the worker B is estimated, and the position of the worker A, that is, the correct position cannot be estimated.

Even within a single cell, details of work of a worker differ depending on a position where the worker performs the work. For example, even when the worker A performs a process of assembling a product 1, details of work differ depending on a position where the worker A performs the process. Even in the process of assembling the same product 1, components differ depending on an orientation of the worker A to the product 1. Positions where the assembly process, a machining process, and an inspection process are performed are different, and details of work in the processes are different. Therefore, it is necessary to accurately grasp the position and orientation of the worker A.

In such a case, the work support tends to become ambiguous, and improving the accuracy of the work support is required. In particular, it is required to ensure the close relationship between visual and linguistic aspects in the work support, such as an instruction on a direction in which worker needs to face during work. If such the appropriate work support cannot be performed, time and effort may be required to resolve an unforeseen event in the production site, work may be stopped, and a delivery date may be delayed. In the present embodiment, similar cells that are difficult to distinguish are identified, and the appropriate work support is performed for a work target that depends on a position such as the position and orientation of the worker in response to an unforeseen event that has occurred.

Therefore, in the present embodiment, a work support system calculates the position information of the worker from a field-of-view image and a captured production-site floor image that are based on the target area three-dimensional space information of a target area where the worker is present in order to perform the work support for the worker. As described above, in the present embodiment, the area is used as an environment of the worker A.

The field-of-view image is extracted from the three-dimensional space information based on a virtual field-of-view and a field-of-view direction of the worker A. Therefore, the position information calculated based on the field-of-view image includes a point of view(PoV) of the worker A, that is, a location and a field-of-view direction.

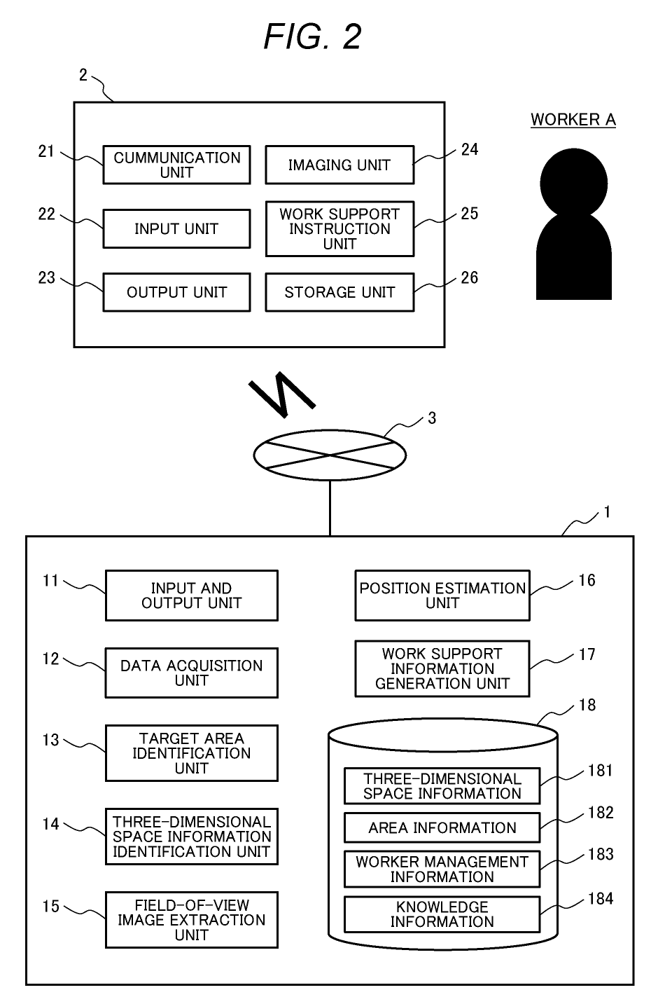

FIG. 2 is a functional block diagram schematically illustrating the work support system according to the present embodiment. In FIG. 2, the work support system includes a work support device 1 and a worker terminal 2 that are connected to each other via a network 3. The work support device 1 is implemented by a computer such as a server and performs the work support based on the position information of the worker A.

The work support is desirably support for handling an unforeseen event but is not limited thereto. The work support device 1 is an example of a position estimation device that estimate the position of the worker A. The work support device 1 may include a position estimation device and a work support device that generates the work support information based on the position information estimated by the position estimation device, or may include only the position estimation device.

The work support device 1 includes an input and output unit 11, a data acquisition unit 12, a target area identification unit 13, a three-dimensional space information identification unit 14, a field-of-view image extraction unit 15, a position estimation unit 16, a work support information generation unit 17, and a storage unit 18.

First, the input and output unit 11 receives a captured production-site floor image from the worker terminal 2 and receives input data from the worker A. In addition, the input and output unit 11 outputs the position information of the worker A estimated by the work support device 1 and/or the generated work support information.

Therefore, the input and output unit 11 can be implemented by a communication device that communicates with the worker terminal 2. Further, the input and output unit 11 can be implemented by an input device that receives an operation from the worker, an administrator, or the like, and an output device that outputs a processing result such as the position information and the work support information.

In addition, the data acquisition unit 12 acquires the captured production-site floor image and the input data via the input and output unit 11. The data acquisition unit 12 may determine whether to perform a subsequent work support process based on the acquired information. This determination may be a determination as to whether to perform a process of estimating the position information. The captured production-site floor image is an image captured by a device such as the worker terminal 2 carried or worn by the worker A. The captured production-site floor image can be considered to indicate a field of view and a field of vision of the worker A.

In addition, the target area identification unit 13 identifies, based on the input data, area information of a target area range where the worker A is present. In the present embodiment, the target area range indicates an area where the worker A is present among areas that serve as management units of the position information. However, the target area range may be an entire region handled by the work support device 1 or may be areas into which the target area range is divided.

For example, as the areas, areas for work management according to the work, such as the work cells illustrated in FIG. 1 or work areas in the process of assembling the product 1, can be used. In addition, divided areas obtained by forming the work cells into predetermined shapes may be used. The target area identification unit 13 may identify a work management unit area or a plurality of work management unit areas as the target area range. The three-dimensional space information identification unit 14 extract the area information of the target area range from area information of the product line in the storage unit 18 in order to identify the area information of the target area range.

In addition, the three-dimensional space information identification unit 14 identifies, based on the area information, the target area three-dimensional space information that is three-dimensional space information of the target area range identified by the target area identification unit 13. Therefore, the three-dimensional space information identification unit 14 narrows down three-dimensional space information 181 of the product line stored in the storage unit 18 to extract the target area three-dimensional space information.

In addition, the field-of-view image extraction unit 15 extracts the field-of-view image of the worker A from the target area three-dimensional space information identified by the three-dimensional space information identification unit 14. In this case, the field-of-view image is an image corresponding to field-of-view information of the worker A and virtually indicating a field of view (field of vision) of the worker A. In the present embodiment, as the field-of-view information, field-of-view information including a point of view and a field-of-view direction is used. However, the field-of-view information may include the point of view and/or the field-of-view direction, and may include, for example, only the point of view.

The target area identification unit 13 and the three-dimensional space information identification unit 14 can be omitted. For example, the narrowing down of the three-dimensional space information 181 of the production line stored in the storage unit 18 that is performed by the three-dimensional space information identification unit 14 can be omitted. In this case, the field-of-view image extraction unit 15 extracts the field-of-view image of the worker A from the target area three-dimensional space information that is three-dimensional space information of the target area range where the worker A is present. In this case, the target area three-dimensional space information may be identified based on the input data acquired by the data acquisition unit 12, or the three-dimensional space information 181 of the production line stored in the storage unit 18 may be used for the target area three-dimensional space information.

In addition, the position estimation unit 16 calculates the position information indicating the position of the worker A by comparing the field-of-view image extracted by the field-of-view image extraction unit 15 with the captured production-site floor image acquired by the data acquisition unit 12. As a result, the position of the worker A can be estimated. In this case, the position estimation unit 16 estimates, as the position of the worker A, a position indicated in the field-of-view image included in the extracted field-of-view image and corresponding to the captured production-site floor image. Therefore, the three-dimensional space information 181 is provided with the point of view and/or the field-of-view direction as the position information.

In the present embodiment, the data acquisition unit 12 acquires the production-site floor image in a time zone including the time when an unforeseen event occurs. In addition, the target area identification unit 13 identifies area information of a target area range of the worker A when the unforeseen event occurs. As a result, the three-dimensional space information identification unit 14 identifies the target area three-dimensional space information of a target area where the worker A is present when the unforeseen event occurs. Then, the position estimation unit 16 calculates the position information indicating the position of the worker A when the unforeseen event occurs.

In addition, the work support information generation unit 17 generates, based on the calculated position information, the work support information indicating handling of the unforeseen event for the worker A. In response to this, the work support information generation unit 17 outputs the work support information using the input and output unit 11. As a result, the worker A can check the work support information and handle the unforeseen event. Further, the work support information generation unit 17 can determine a method for presenting the work support information, for example, can determine whether to output the work support information as audio data.

The worker A and the administrator may check the work support information output by the input and output unit 11. Further, the worker A may check the work support information output by an output unit 23 of the worker terminal 2 from the input and output unit 11 via the network 3.

The input and output unit 11 and the output unit 23 may be implemented as display devices or may be audio output devices such as speakers. As a result, the worker A and the administrator can check the work support information via a display screen or audio data.

The storage unit 18 stores the three-dimensional space information 181, area information 182, worker management information 183, and knowledge information 184. The three-dimensional space information 181 indicates the three-dimensional space information of the product line and is provided with the position information of each unit position.

The area information 182 indicates information identifying target three-dimensional space information corresponding to each area. As the information identifying the target three-dimensional space information, information regarding a corresponding area can be used. For example, area information 182 associated with the position information (range) and details of work for each area name or each area identification information piece can be used. In addition, the worker may be used as the information regarding the area. In this case, for the details of the work and the worker, it is desirable to record a corresponding time zone.

In addition, the worker management information 183 is the information regarding workers including the worker A. The worker management information 183 includes, for example, workers’ levels of skill (experience), work that the workers are responsible for, and a method for presenting the work support information.

Further, the knowledge information 184 indicates knowledge for performing the work support, for example, knowledge for identifying a method for handling an unforeseen event. In this case, a handling method based on details of work at a position indicated in the position information and the workers’ levels of skill can be identified from the knowledge.

Therefore, the work support information generation unit 17 generates the work support information using the calculated position information and the knowledge information 184. In this case, it is desirable that the work support information generation unit 17 generate the work support information based on identification information of the worker A included in the input data. As a result, the work support information generation unit 17 can generate the work support information in a format suitable for the worker A. For example, the format may be an audio format or a text format or may be a language suitable for the worker A.

Next, the worker terminal 2 will be described. The worker terminal 2 is an information processing device that the worker A carries or wears. Therefore, the worker terminal 2 can be implemented by a so-called wearable terminal, a mobile terminal such as a smartphone, or a combination thereof. The worker terminal 2 acquires the captured production-site floor image and the input data and transmits the captured production-site floor image and the input data to the work support device 1 via the network 3. In addition, the worker terminal 2 receives the work support information from the work support device 1 and outputs the received work support information.

Therefore, the worker terminal 2 includes a communication unit 21, an input unit 22, an output unit 23, an imaging unit 24, a work support instruction unit 25, and a storage unit 26. The communication unit 21 is connected to the work support device 1 via the network 3. Therefore, the communication unit 21 transmits the input data and the captured production-site floor image to the work support device 1. In addition, the communication unit 21 receives the work support information from the work support device 1.

In addition, the input unit 22 receives an operation and input data from the worker A. In this case, the input data includes the target area range of the worker A. Therefore, the input unit 22 receives the target area range and details of work from the worker A. Then, the work support instruction unit 25 described later generates input data from the received range and the received details of the work. The input data includes a request for the work support. For example, when an unforeseen event occurs, the input unit 22 receives, from the worker A, question information indicating that the unforeseen event occurred, and question information for making an inquiry about the unforeseen event, and the request for the work support is generated in response to the reception of the information.

In addition, the input unit 22 can be implemented by an input device such as a touch panel or buttons. In this case, the information indicating the unforeseen event that has occurred and the question information are input as audio data to the input unit 22. Further, the input unit 22 may be implemented by an audio input device such as a microphone, or an input device and the audio input device may be disposed as the input unit 22. The audio input device may be disposed separately from the worker terminal 2.

Such an audio input device may be disposed in each area of the production line. In this case, the audio input device and the work support instruction unit 25 may generate input data by associating collected audio data with area information identifying a corresponding area.

In addition, the output unit 23 outputs information such as the work support information. Therefore, the output unit 23 can be implemented by a display device such as a touch panel. The input unit 22 and the output unit 23 may be configured as an integrated unit like a touch panel.

In addition, the imaging unit 24 can be implemented by a camera and captures an production-site floor image. The imaging unit 24 may be disposed separately from the worker terminal 2. The work support instruction unit 25 performs a process of supporting work of the worker A.

In addition, the work support instruction unit 25 generates input data, generates, based on the generated input data, input data indicating an instruction for creating the work support information to be provided to the work support device 1, and controls output of the work support information. The control includes outputting the work support information to the output unit 23 with priority over other information in response to an unforeseen event. When the input unit 22 receives details of work, the work support instruction unit 25 identifies a target area range corresponding to the details of the work and generates input data including the identified target area range.

The work support instruction unit 25 may be omitted. In this case, the input unit 22 uses the received details as the input data.

In addition, the work support instruction unit 25 may generate the work support information. In this case, the worker terminal 2 receives the calculated position information from the work support device 1, and the work support instruction unit 25 generates, based on the received position information, the work support information indicating handling of an unforeseen event for the worker A.

The storage unit 26 stores various information. For example, the input data, the captured production-site floor image, and the work support information are stored in the storage unit 26. The information may be temporarily stored. This concludes the description of the configuration according to the present embodiment. Worker terminals 2 are provided for respective workers. However, the audio input device is exceptional.

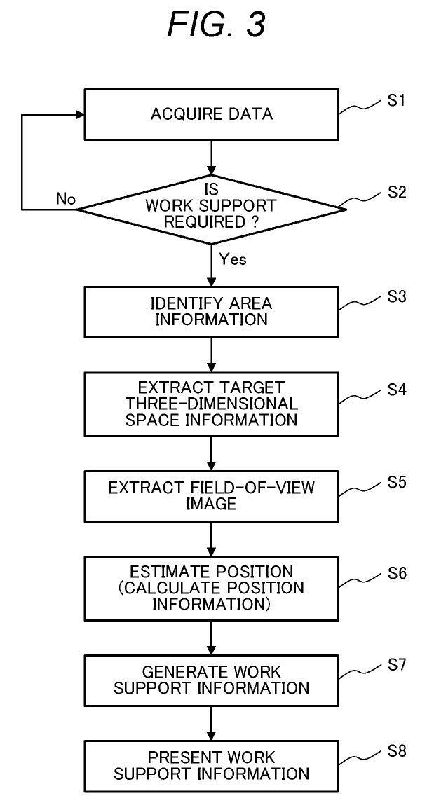

Next, the work support process according to the present embodiment will be described. FIG. 3 is a flowchart illustrating a procedure for the work support process according to the present embodiment. First, in step S1, the data acquisition unit 12 acquires data from the worker terminal 2 via the input and output unit 11. The data includes the input data and the captured production-site floor image. The input data is acquired when the input data is input from the worker A.

Therefore, the input unit 22 and the imaging unit 24 of the worker terminal 2 acquires the input data and the captured production-site floor image.

In step S2, the data acquisition unit 12 determines, based on the acquired input data and/or the captured production-site floor image, whether the work support is required. That is, the data acquisition unit 12 determines whether processing in step S3 and the subsequent steps is to be performed.

For example, in a case where the input data includes a request for the work support, the data acquisition unit 12 determines that the work support is required.

When detecting that an unforeseen event has occurred from the acquired captured production-site floor image, the data acquisition unit 12 may determine that input the work support is required. As described above, the work support process according to the present embodiment is performed on the condition that user information input by the worker A or the captured production-site floor image satisfies a predetermined condition. However, a condition for the work support process may be input of question information from the worker A.

In a case where the input data includes audio data, the data acquisition unit 12 may determine that input the work support is required. In this case, when the worker makes a sound regardless of the content, the data acquisition unit 12 may determine that the work support is required.

In a case where the work support is required, when the work support instruction unit 25 of the worker terminal 2 causes the input data and the captured production-site floor image to be transmitted from the communication unit 21, and the data acquisition unit 12 receives the input data and the captured production-site floor image, the data acquisition unit 12 determines that the work support is required. If the work support is required (Yes) as a result of the determination in step S2, the process proceeds to step S3. If the work support is not required (No), the process returns to step S1 and a process of acquiring data is performed.

In step S3, the target area identification unit 13 identifies, based on the input data received in step S1, area information of a target area range including a position where the worker A is present. For example, the target area identification unit 13 may extract the target area range from the input data, treat the extracted target area range as the area information, and extract the area information stored in advance from the target area range.

The target area identification unit 13 may identify the target area range in the following manner. First, the target area identification unit 13 compares the identification information of the worker A included in the input data with the worker management information 183 to identify work that the worker A is responsible for. The target area identification unit 13 identifies, from the knowledge information 184 or the like, the target area range where the work that the worker A is responsible for is performed.

In step S4, the three-dimensional space information identification unit 14 identifies the target area three-dimensional space information of the target area range based on the area information identified in step S3. Therefore, the three-dimensional space information identification unit 14 extracts, from the three-dimensional space information 181 stored in the storage unit 18, three-dimensional space information of a position indicated in the area information identified in step S3 as the target area three-dimensional space information.

In step S5, the line-of-image extraction unit 15 extracts the field-of-view image of the worker A from the target area three-dimensional space information identified in step S4. In step S6, the position estimation unit 16 calculates the position information indicating the position of the worker A by comparing the field-of-view image extracted in step S5 with the captured production-site floor image acquired in step S1.

In this case, the position estimation unit 16 calculates, as the position information of the worker A, the position information in the field-of-view image included in the extracted field-of-view image and corresponding to the captured production-site floor image. The fact that the field-of-view image corresponds to the captured production-site floor image indicates that the field-of-view image is the same as the extracted field-of-view image, or includes the fact that the field-of-view image is the same as the extracted field-of-view image.

In step S7, the work support information generation unit 17 generates, based on the position information calculated in step S6, the work support information indicating handling of an unforeseen event for the worker A. In this case, the work support information generation unit 17 further uses the knowledge information 184.

In step S8, the work support system presents the work support information generated in step S7 to the worker A. Therefore, the work support information generation unit 17 transmits the generated work support information to the worker terminal 2 via the input and output unit 11. The work support information is an example of position-related information regarding the calculated position information, and work-related information indicating a work procedure and design information may be used as the work support information.

The output unit 23 of the worker terminal 2 outputs the work support information. The output can be implemented by display and/or audio output. As a result, the worker A can check the work support information in response to the unforeseen event and can appropriately handle the unforeseen event.

According to the present embodiment, it is possible to perform the appropriate work support in response to an unforeseen event. However, the present embodiment is applicable to the work support during normal time other than unforeseen events and to the work support for schedule management and the like. The work support information generation unit 17 may be omitted, and the work support system and the work support device may be configured as a position estimation system and a position estimation device that provide the calculated position information.

The functions of the work support device 1 according to the present embodiment may be disposed in the worker terminal 2. In this case, only some of the functions, such as the position estimation unit 16 of the work support device 1, may be disposed in the worker terminal 2.

In the present embodiment, various wearable terminals such as a watch-type terminal and a glasses-type wearable terminal, can be used as the worker terminal 2. Embodiments that are specific examples of the present embodiment will be described below.

### First Embodiment

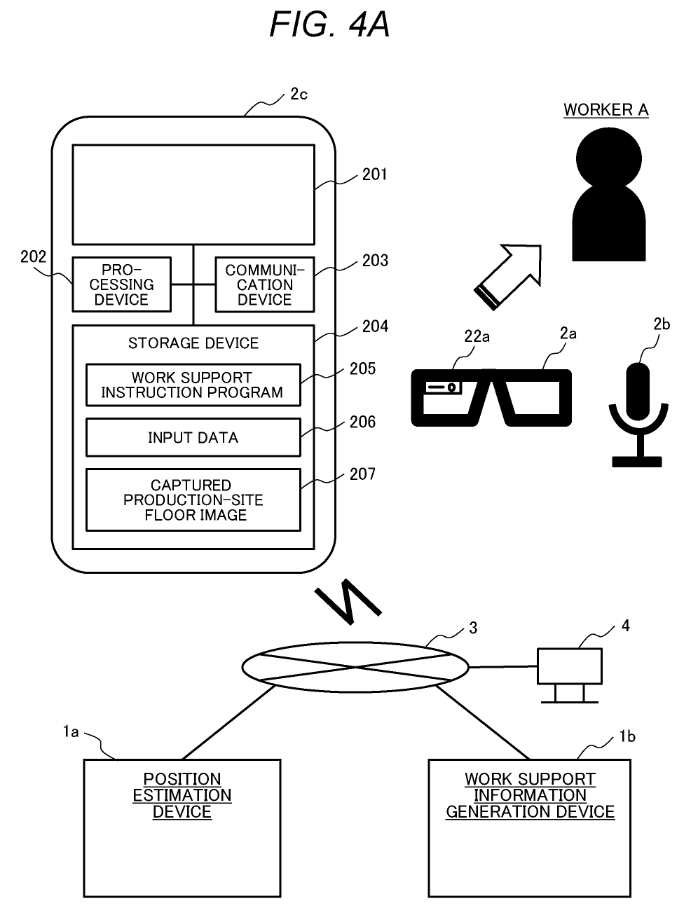

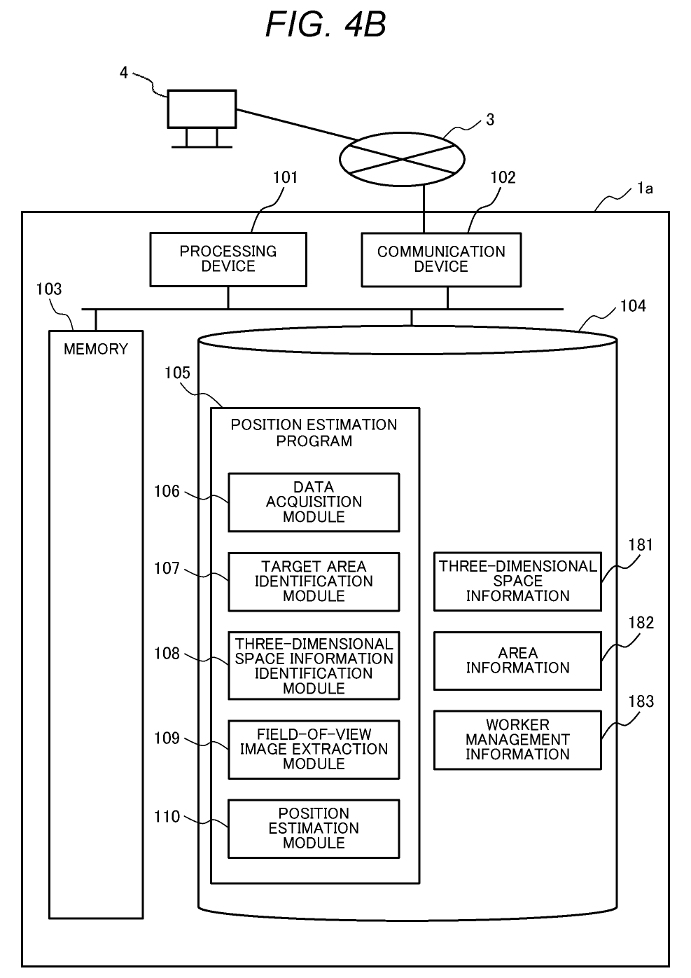

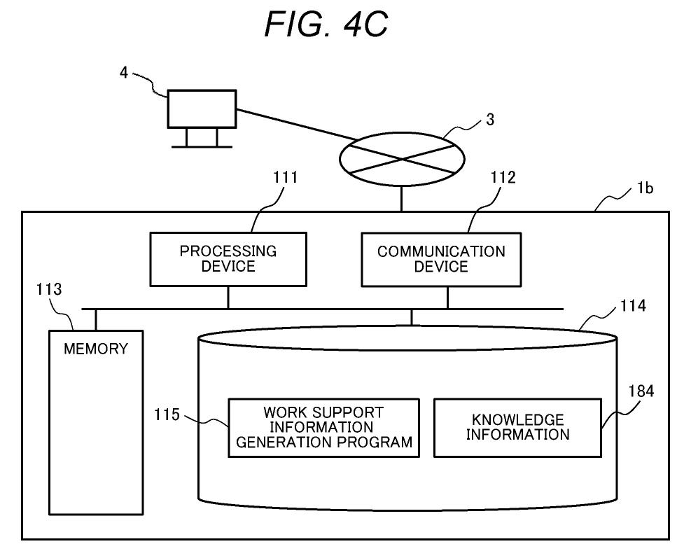

In a first embodiment, an example in which a work support system is configured using a wearable terminal 2a is described. A configuration according to the first embodiment will be described with reference to FIGS. 4A to 4C. The entire work support system according to the first embodiment and each device that implements a worker terminal 2 will be described with reference to FIG. 4A.

In FIG. 4A, the work support system includes a position estimation device 1a, a work support information generation device 1b, the wearable terminal 2a, a sound collection device 2b, a smartphone 2c, and an administrator terminal 4 that are connected to each other via the network 3.

In the first embodiment, an example in which functions of the work support device 1 are implemented by the position estimation device 1a and the work support information generation device 1b is described. Each of functions of the worker terminal 2 is implemented by the wearable terminal 2a, the sound collection device 2b, and the smartphone 2c. In the first embodiment, the administrator terminal 4 that is used by an administrator that performs the work support such as an advice for the worker A is disposed.

Next, details of the wearable terminal 2a, the sound collection device 2b, and the smartphone 2c that implement the functions of the worker terminal 2 will be described.

The wearable terminal 2a according to the first embodiment is configured in the form of glasses and is worn on the head of the worker A. The wearable terminal 2a includes a camera 22a that implements the function of the imaging unit 24.

The wearable terminal 2a may include the function of the output unit 23. For example, the wearable terminal 2a may include a head mounted display and a speaker and output the work support information and the like. The wearable terminal 2a may include a microphone as the function of the input unit 22 and may include an input function of inputting data corresponding to a gesture.

The sound collection device 2b is an example of an audio input device that implements the function of the input unit 22 that receives audio data. In the first embodiment, the sound collection device 2b is disposed separately from the wearable terminal 2a and the smartphone 2c, but a microphone may be disposed in at least one of the wearable terminal 2a and the smartphone 2c and implement the sound collection device 2b.

In the first embodiment, the sound collection device 2b may be disposed in each area of the production line and can acquire audio data other than data from the worker A. However, the sound collection device 2b may be prepared for each worker and worn by each worker. In addition, the sound collection device 2b is desirably connected to the network 3 via a device that is the smartphone 2c or the like and has a communication function, but is not limited thereto.

The smartphone 2c is carried by the worker A and implements the functions of the work support instruction unit 25, and acquires an production-site floor image captured by the camera 2a and audio data collected by the sound collection device 2b. Therefore, the smartphone 2c uses near-field wireless communication or the like so as to be connected to the wearable terminal 2a and the sound collection device 2b and acquire information from the wearable terminal 2a and the sound collection device 2b. In the first embodiment, the smartphone 2c is used, but a tablet terminal or a laptop computer may be used. The smartphone 2c, the tablet terminal, or the laptop computer may be located near a location where the worker A performs work, and may not be carried by the worker A.

As illustrated in FIG. 4A, the smartphone 2c includes a touch panel 201, a processing device 202, a communication device 203, and a storage device 204 that are connected to each other. The touch panel 201 serves as the input unit 22 and the output unit 23 and can receive an operation from the worker A and display the work support information.

However, the input function and the output function can be implemented by the wearable terminal 2a and the sound collection device 2b, and thus can be omitted. The processing device 202 can be implemented by a processor such as a central processing unit (CPU) and implements the functions of the work support instruction unit 25 in accordance with a work support instruction program 205 stored in the storage device 204 described later.

The communication device 203 is connected to the position estimation device 1a, the work support information generation device 1b, and the administrator terminal 4 via the network 3. In the first embodiment, functions of the worker terminal 2 are implemented by a plurality of devices, but may be implemented by the wearable terminal 2a or the smartphone 2c. In the former case, the wearable terminal 2a includes a processing device, the input function, and the output function. In the latter case, the camera and a microphone included in the smartphone 2c are used.

The storage device 204 stores the work support instruction program 205, input data 206 and a captured production-site floor image 207. The input data 206 and the captured production-site floor image 207 are acquired by the wearable terminal 2a, the sound collection device 2b, and the smartphone 2c, and transmitted to the position estimation device 1a.

Next, FIG. 4B is a diagram illustrating an example of the position estimation device 1a according to the first embodiment. The position estimation device 1a implements the processing in steps S1 to S6 according to the embodiment and implements the functions of the input and output unit 11 to the position estimation unit 16 and the storage unit 18 illustrated in FIG. 2.

The position estimation device 1a can be implemented by a computer such as a server. Therefore, as illustrated in FIG. 4B, the position estimation device 1a includes a processing device 101, a communication device 102, a memory 103, and an auxiliary storage device 104 that are connected to each other via a communication path.

The processing device 101 can be implemented by a processor such as a CPU and performs calculation in accordance with a position estimation program 105 stored in the auxiliary storage device 104 described later. The communication device 102 is connected to the wearable terminal 2a, the sound collection device 2b, the smartphone 2c, the work support information generation device 1b, and the administrator terminal 4 via the network 3.

Therefore, the communication device 102 receives the input data and the captured production-site floor image from the wearable terminal 2a, the sound collection device 2b, and the smartphone 2c. The communication device 102 outputs the calculated position information. Therefore, the communication device 102 implements the functions of the input and output unit 11 according to the embodiment described above. The communication device 102 transmits the calculated position information to at least one of the work support information generation device 1b, the wearable terminal 2a, the smartphone 2c, and the administrator terminal 4.

The memory 103 and the auxiliary storage device 104 can be implemented by storage media and implement the function of the storage unit 18 described above. The position estimation program 105 stored in the auxiliary storage device 104 and data to be used in processing by the processing device 101 are loaded into the memory 103. The auxiliary storage device 104 can be implemented by so-called storage.

The auxiliary storage device 104 stores the above-described position estimation program 105, the three-dimensional space information 181, the area information 182 and the worker management information 183. The auxiliary storage device 104 may be implemented by various storage media such as an external hard disk drive (HDD), a solid-state drive (SSD), a main storage device card, or may be implemented by a device that is a file server or the like and is not the position estimation device 1a.

The processing device 101 performs processing of the data acquisition unit 12, the target area identification unit 13, the three-dimensional space information identification unit 14, the line-of-image extraction unit 15, and the position estimation unit 16 in accordance with the position estimation program 105. Therefore, the position estimation program 105 includes a data acquisition module 106, a target area identification module 107, a three-dimensional space information identification module 108, a field-of-view image extraction module 109, and a position estimation module 110.

The modules correspond to the data acquisition unit 12, the target area identification unit 13, the three-dimensional space information identification unit 14, the line-of-image extraction unit 15, and the position estimation unit 16. The modules may be implemented by respective independent programs.

FIG. 4C is a diagram illustrating an example of the work support information generation device 1b according to the first embodiment. The work support information generation device 1b implements a part of steps S7 and S8 according to the embodiment and implements the functions of the input and output unit 11, the work support information generation unit 17, and the storage unit 18 illustrated in FIG. 2.

The work support information generation device 1b can also be implemented by a computer such as a server. Therefore, as illustrated in FIG. 4C, the work support information generation device 1b includes a processing device 111, a communication device 112, a memory 113, and an auxiliary storage device 114 that are connected to each other via a communication path. These devices have the same functions as those of the components of the position estimation device 1a, and differences between the devices and the components will be mainly described.

The processing device 111 performs calculation in accordance with a work support information generation program 115 stored in the auxiliary storage device 114 described later. The communication device 112 receives the position information from the position estimation device 1a via the network 3, and transmits the generated work support information to at least one of the wearable terminal 2a, the sound collection device 2b, the smartphone 2c, and the administrator terminal 4 via the network 3. Therefore, the communication device 112 implements the functions of the input and output unit 11.

The work support information generation program 115 stored in the auxiliary storage device 114 and data to be used for processing by the processing device 111 are loaded into the memory 113. The auxiliary storage device 114 stores the work support information generation program 115 and the knowledge information 184. The processing device 111 performs processing of the work support information generation unit 17 in accordance with the work support information generation program 115.

The position estimation device 1a and the work support information generation device 1b may be configured as the work support device that is a single computer. In this case, the work support device performs processing of the position estimation device 1a and the work support information generation device 1b in accordance with the work support program including the position estimation program 105 and the work support information generation program 115. This concludes the description of the configuration according to the first embodiment.

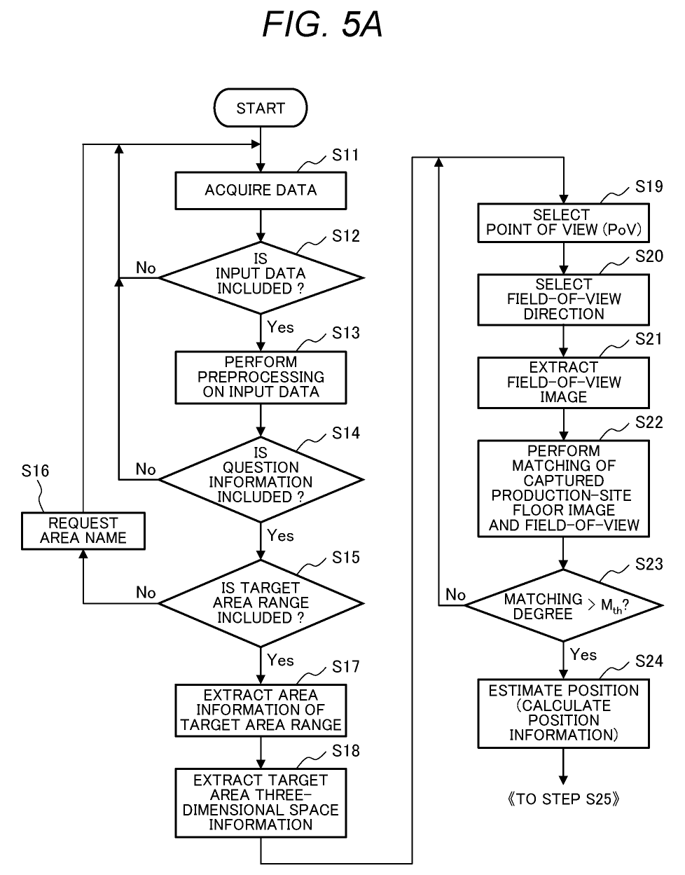

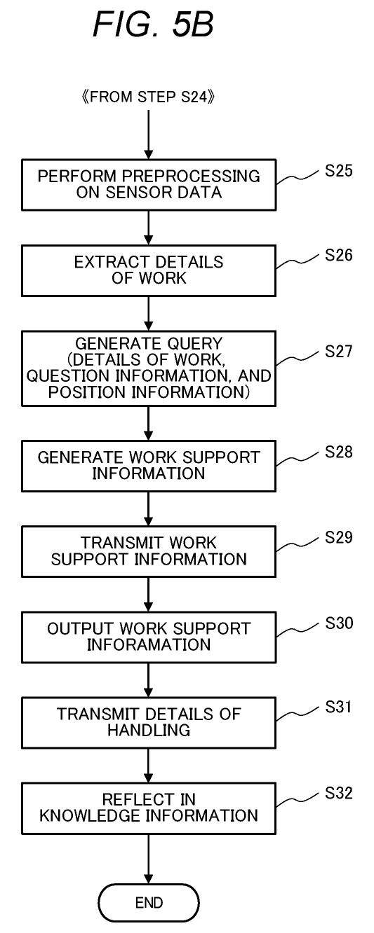

Next, a work support process according to the first embodiment will be described with reference to FIGS. 5A and 5B. In the following description, the configuration illustrated in FIGS. 4A to 4C is used, but can be read as the configuration illustrated in FIG. 2.

The processing device 101 of the position estimation device 1a performs steps S11 to S16 illustrated in FIG. 5 in accordance with the data acquisition module 106. First, in step S11, the processing device 101 acquires data from the wearable terminal 2a via the communication device 102.

Therefore, the wearable terminal 2a, the sound collection device 2b, and the smartphone 2c perform the following processing. First, the camera 22a of the wearable terminal 2a captures an production-site floor image during work of the worker A and acquires the captured production-site floor image. Then, the wearable terminal 2a transmits the captured production-site floor image to the position estimation device 1a via the smartphone 2c or directly. The acquisition of the captured production-site floor image may be performed by the camera of the smartphone 2c.

When the worker A encounters an unforeseen event, the worker A inputs question information for making an inquiry about handling of the unforeseen event to any one of the wearable terminal 2a, the sound collection device 2b, and the smartphone 2c. The question information may include information indicating the unforeseen event, such as “A component of the product 1 is insufficient” or “An incorrect component has been attached”, or may include a request, such as “Please advise on a method for handling (the unforeseen event)”.

Any one of the wearable terminal 2a, the sound collection device 2b, and the smartphone 2c receives the target area range and/or details of work entered by the worker A. When the sound collection device 2b receives the question information, a position where the sound collection device 2b is disposed may be used as the target area range.

Each device receives the information as audio data and/or text data. For example, the sound collection device 2b acquires, as audio data, question information or the like spoken by the worker A. In addition, the smartphone 2c acquires, as text data, question data or the like entered on the touch panel 201 by the worker A. The wearable terminal 2a may receive the question information or the like.

In this case, it is conceivable that the worker A inputs data other than the question information into each device. At least one of the wearable terminal 2a, the sound collection device 2b, and the smartphone 2c receives user information entered as audio data by the worker A.

The smartphone 2c receives the captured production-site floor image and the user information such as the question information from the wearable terminal 2a and the sound collection device 2b via the communication device 203. Then, the processing device 202 of the smartphone 2c generates input data including the user information and the target area range and/or the details of the work in accordance with the work support instruction program 205.

Then, the processing device 202 transmits the input data and the captured production-site floor image to the position estimation device 1a from the communication device 203 in accordance with the work support instruction program 205. The wearable terminal 2a transmits the captured production-site floor image to the position estimation device 1a. The sound collection device 2b may transmit the user information and/or the target area range to the position estimation device 1a. As a result, in step S11, the input data and the captured production-site floor image are acquired. However, the input data is acquired when the worker A enters the user information.

In step S12, the processing device 101 determines whether the input data is included in the data acquired in step S11. If the input data is included (Yes) as a result of the determination, the process proceeds to step S13. If the input data is not included (No), the process returns to step S11.

In step S13, the processing device 101 performs preprocessing on the input data acquired in step S11. In step S14, the processing device 101 determines whether the input data includes question information. If the input data is included (Yes) as a result of the determination, the process proceeds to step S15. If the input data is not included (No), the process returns to step S11. In this case, if the question data is audio data, the processing device 101 may determine that the question information is included.

In step S15, the processing device 101 determines whether the target area range where the worker A is present is included in the input data. In this case, the target area range may be information identifying the target area range. An area name or details of work associated with the identification information or an area can be used. If the input data is included (Yes) as a result of the determination, the process proceeds to step S17. If the target area range is not included (No), the processing device 101 transmits inquiry information for making an inquiry about the area name indicating the target area range to the smartphone 2c or the wearable terminal 2a via the communication device 102.

The area name that the worker A is likely to know is used in step S16, but an inquiry regarding another item may be made since it suffices for the target area range to be identified. The input data basically includes the target area range, but steps S15 and S16 are performed to handle an input omission by the worker A or the like.

However, these steps may be skipped. The input of the question information may be set as a condition for creating input data, and steps S12 to S14 may be skipped. By steps S12 to S16 described above, the determination as to whether the work support described with reference to FIG. 3 is required is implemented. That is, in the first embodiment, whether the work support is required is determined based on whether the input data, the question information, and the target area range are present. A part of the input data, the question information, and the target area range may be omitted and another condition may be used.

In step S17, the processing device 101 extracts, from the area information 182 stored in the auxiliary storage device 104, the area information of the target area range included in the acquired input data in accordance with the target area identification module 107. As the area information, the target area range included in the input data may be used.

In step S18, the processing device 101 extracts, from the three-dimensional space information 181 stored in the auxiliary storage device 104, the target area three-dimensional space information of the target area range based on the area information extracted in step S18 in accordance with the three-dimensional space information identification module 108. Since the three-dimensional space information 181 is in a format identifiable in each area, three-dimensional space information of each area can be identified based on the area information. Some specific examples of the process of extracting the three-dimensional space information in step S18 are conceivable. These specific examples will be described later.

The processing device 101 performs steps S19 to S23 in accordance with the field-of-view image extraction module 109. First, in step S19, the processing device 101 selects any candidate point of view from a plurality of candidate point of views of the worker A included in the target three-dimensional space information extracted in step S18. In addition, in step S20, the processing device 101 selects any candidate field-of-view direction from a plurality of candidate field-of-view directions of the worker A included in the target three-dimensional space information extracted in step S18.

In step S21, the processing device 101 identifies the field-of-view image that corresponds to the selected candidate point of view and the selected candidate field-of-view direction and may serve as a field of view of the worker A. Therefore, the processing device 101 extracts, from the three-dimensional space information 181, the field-of-view image identified from a combination of the selected candidate point of view and the selected candidate field-of-view direction.

In step S22, the processing device 101 compares (matches) the captured production-site floor image acquired in step S11 with the field-of-view image extracted in step S21. In step S23, the processing device 101 determines whether a matching degree that indicates a similarity indicating a result of the matching is greater than a predetermined threshold value Mth.

If the matching degree is greater than the threshold value Mth (Yes), the processing device 101 identifies the corresponding field-of-view image as the field-of-view image to be used for position estimation, and the process proceeds to step S24. If the matching degree is not greater than the threshold value Mth (No), the process returns to step S19, and the processing device 101 extracts a next candidate point of view and a next candidate field-of-view direction and extracts the field-of-view image based on the extracted next candidate point of view and the extracted next candidate field-of-view direction. The order of candidate point of views and candidate field-of-view directions in steps S19 and S20 is not limited since various methods are conceivable.

In steps S18 to S21, the processing device 101 may identify the three-dimensional space information, identify, from the identified three-dimensional space information, candidates that may serve as field-of-view information including a point of view and a field-of-view of the worker A, and extract a plurality of field-of-view images using the identified candidates. As described above, it suffices for the field-of-view information to include at least one of the point of view and the field-of-view of the worker A.

The processing device 101 may identify the field-of-view image with the highest matching degree among the plurality of field-of-view images. The process of extracting the field-of-view image in steps S19 to S21 described above is to extract the field-of-view image by three-dimensionally scanning a space indicated in the three-dimensional space information 181.

Some processing methods (specific examples) are conceivable for the process of extracting the field-of-view image in steps S19 to S21. These specific examples will be described later.

In step S24, the processing device 101 estimates a point of view in the field-of-view image identified in step S23 as the position of the worker A in accordance with the position estimation module 110. That is, the processing device 101 calculates, as the position information indicating the position of the worker A, the position information indicated by the point of view in the field-of-view image identified in step S23. Then, the processing device 101 outputs the calculated position information via the communication device 102. In the first embodiment, the processing device 101 transmits the position information to the work support information generation device 1b, but may transmit the position information to the administrator terminal 4, the smartphone 2c, or the wearable terminal 2a.

When receiving the position information, the administrator terminal 4 can display the transmitted position information. In this case, it is desirable that the administrator terminal 4 acquire the captured production-site floor image and the details of the work and display the position information together with the captured production-site floor image and the details of the work. In response to this, the administrator can input, to the administrator terminal 4, advice such as an appropriate method for handling an unforeseen event that have occurred for the worker A. As a result, the administrator terminal 4 transmits the input advice to the wearable terminal 2a and the smartphone 2c. Therefore, the worker A can handle the unforeseen event.

When receiving the position information, the smartphone 2c or the wearable terminal 2a can output the position information. The smartphone 2c or the wearable terminal 2a can compare a manual stored in the smartphone 2c or the wearable terminal 2a with the position information, identify a method for handling the unforeseen event, and output the identified method. As a result, the worker A can handle the unforeseen event that has occurred.

In step S24, it is desirable that the processing device 101 output at least a portion of the input data including the captured production-site floor image and the details of the work. Then, the work support process may be ended, but processing in step S25 and the subsequent steps illustrated in FIG. 5B is performed in the first embodiment.

When the communication device 112 of the work support information generation device 1b receives the position information from the position estimation device 1a, the processing device 111 performs steps S25 to S29 illustrated in FIG. 5B in accordance with the work support information generation program 115.

First, in step S25, the processing device 111 acquires sensor data from a sensor disposed in the production line and performs preprocessing for analyzing the sensor data. As the sensor data, the captured production-site floor image may be used. In step S26, the processing device 111 identifies, based on the sensor data, details of work in a target area range indicated in the position information in the production line. That is, the status of the unforeseen event is identified.

In step S27, the processing device 111 generates a query for the details of the work based on the identified details of the work, and question information and the position information that are included in the input data. In response to this, in step S28, the processing device 111 generates the work support information for the generated query, that is, the work support information indicating a method for handling the unforeseen event. In this case, the processing device 111 uses the knowledge information 184 stored in the auxiliary storage device 114.

In step S29, the processing device 111 transmits the generated work support information via the communication device 112. In step S29, the work support information is transmitted to the wearable terminal 2a and/or the smartphone 2c. As a result, the worker A check the work support information and can appropriately handle the unforeseen event.

In step S29, the work support information may be transmitted to the administrator terminal 4. In this case, the administrator can check the work support information and confirm whether the work support information is correct. Then, the administrator inputs, to the administrator terminal 4, an instruction to modify the work support information and information indicating that the work support information can be approved.

In response to this, the administrator terminal 4 transmits, to the wearable terminal 2a and/or the smartphone 2c, the work support information according to the input. As a result, the worker A can check the work support information.

In step S30, as described above, the wearable terminal 2a and/or the smartphone 2c and the administrator terminal 4 output the transmitted work support information. The work support information may be output as audio data or displayed on a screen. The work support information may be output as audio data and displayed on the screen.

In step S31, at least one of the wearable terminal 2a, the sound collection device 2b, and the smartphone 2c transmits, to the work support information generation device 1b, details of handling the unforeseen event by the worker A. As the details of handling, the captured production-site floor image may be used.

When the communication device 112 of the work support information generation device 1b receives the method for handling, the processing device 111 performs step S32 in accordance with the work support information generation program 115. In step S32, the processing device 111 reflects the received method for handling in the knowledge information 184. This reflection includes association of the unforeseen event that has occurred with the details of the handling and recording of the unforeseen event that has occurred and the details of the handling. Then, the work support process of this flowchart is ended.

The process of extracting target three-dimensional space information and the process of extracting the field-of-view image in steps S18 to S21 will be described. First and second specific examples of the process of extracting target three-dimensional space information will be described first. In the description of the specific examples, the process of extracting the field-of-view image using a result of the process of extracting target three-dimensional space information is also described.

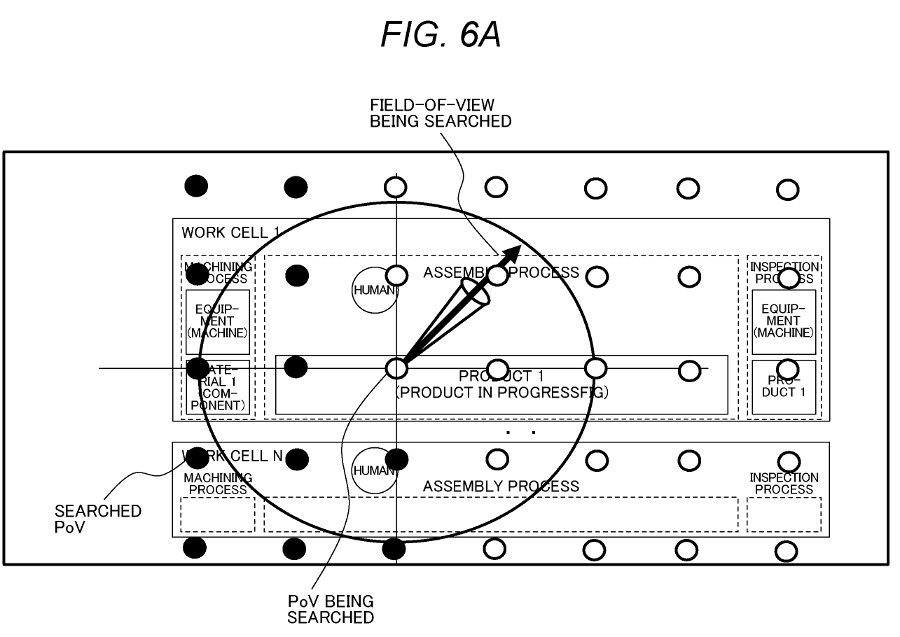

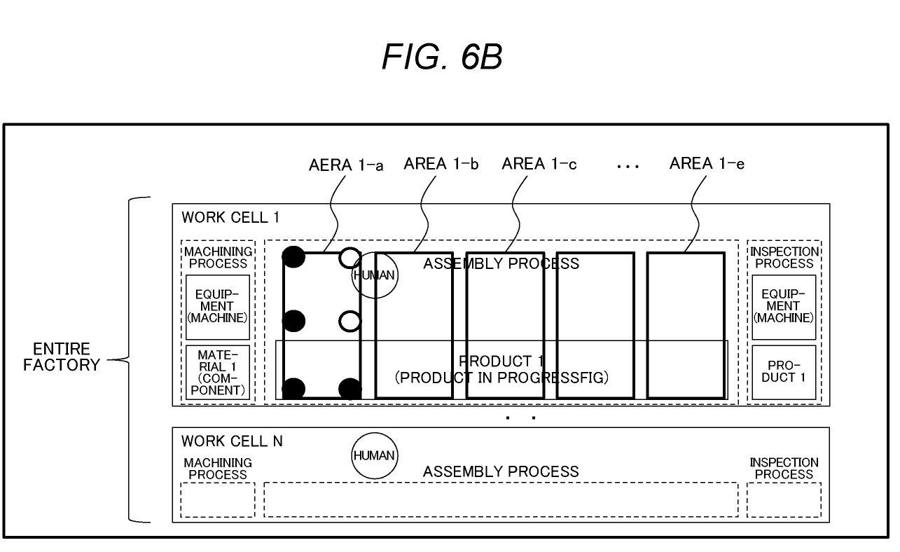

In the first specific example, three-dimensional space information of all areas in the production line is extracted as target three-dimensional space information from the three-dimensional space information 181. FIG. 6A is a diagram schematically illustrating a first specific example of a process of extracting target three-dimensional space information according to the first embodiment.

First, candidate point of views at predetermined intervals in the production line are recorded in the three-dimensional space information 181. In FIG. 6A, the candidate point of views are indicated by circle marks. The processing device 101 extracts, from the three-dimensional space information 181, three-dimensional space information of the entire production line as target three-dimensional space information.

In steps S19 and S20, the processing device 101 extracts candidate point of views and candidate field-of-view directions from the target three-dimensional space information indicating the entire production line. These candidate point of views are searched in a predetermined order (for example, in vertically opposite directions from the top left in the drawing). In FIG. 6A, black circles indicate searched candidate point of views, that is, extracted candidate point of views, and white circles indicate candidate point of views being searched, that is, candidate point of views that are not yet extracted.

The processing device 101 rotates a virtual field of vision around a searched candidate point of view from any direction, and identifies a candidate field-of-view direction for each predetermined angle. In the drawing, an arrow indicates a candidate field-of-view direction being searched. The processing device 101 extracts the field-of-view image for each candidate field-of-view direction corresponding to a candidate point of view. In the drawing, an ellipse around the arrow indicating the candidate field-of-view direction is the field-of-view image that is the virtual field of vision of the worker A. As a result, the field-of-view image includes a location indicated by the point of view and the field-of-view direction, and the position information calculated based on the field-of-view image includes the location and the field-of-view direction.

In the first specific example, since each position (candidate point of view) in the production line and a candidate field-of-view direction corresponding to the position are comprehensively scanned and a field-of-view is extracted, it is possible to calculate the position information with high accuracy. In the first specific example, the target area range is used as the entire production line, that is, the entire three-dimensional space information 181.

Next, in the second specific example of the process of extracting target three-dimensional space information, three-dimensional space information of an area included in the three-dimensional space information 181 and narrowed down from the three-dimensional space information of the entire production line is extracted as target three-dimensional space information.

FIG. 6B is a diagram schematically illustrating a second specific example of a process of extracting the target three-dimensional space information according to the first embodiment. In FIG. 6B, black circles indicate searched candidate point of views, and white circles indicate candidate point of views being searched.

In the second specific example, the three-dimensional space information 181 is divided into areas constituting the production line. In the second specific example, the processing device 101 identifies, from each area of the three-dimensional space information 181, an area corresponding to the target area range included in the input data. In the example illustrated in FIG. 6B, an area 1-a is identified. As described above, in the second specific example, the areas are narrowed down to the area 1-a in the three-dimensional space information 181. Then, the processing device 101 extracts three-dimensional space information of the narrowed down area 1-a as target three-dimensional space information from the three-dimensional space information 181.

In steps S19 to S21, the processing device 101 extracts the field-of-view image for each of candidate field-of-view directions corresponding to respective candidate point of views in the identified area 1-a. This extraction method can be implemented as in the first specific example. In the second specific example, it is possible to reduce the amount of information used and the amount of data processed and to efficiently extract the field-of-view image.

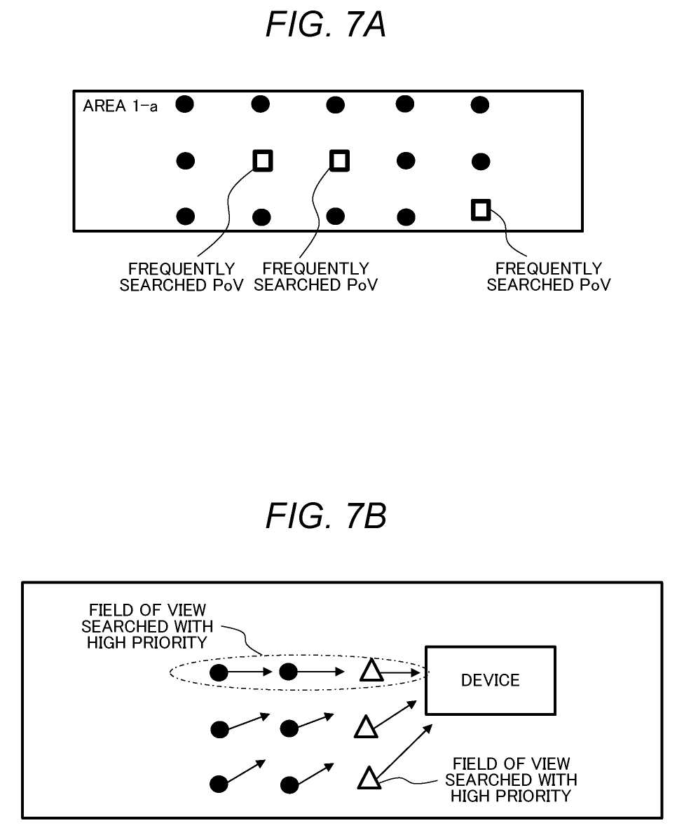

Next, first and second specific examples of the process of extracting the field-of-view image will be described. In the first and second specific examples of the process of extracting the field-of-view image, the field-of-view images are extracted in a predetermined order of priority. In the first specific example, the candidate point of views and the candidate field-of-view directions are narrowed down and the field-of-view image is extracted. FIG. 7A is a diagram schematically illustrating a first specific example of a process of extracting the field-of-view image according to the first embodiment. In FIG. 7A, white rectangles indicate frequently searched candidate point of views that are to be processed with priority. In FIG. 7A, black circles indicate non-prioritized candidate point of views.

Therefore, in the three-dimensional space information 181 or the area information 182, whether each candidate point of view is a frequently searched candidate point of view and whether each candidate field-of-view direction is a frequently searched candidate field-of-view direction are recorded. The frequently searched candidate point of view corresponds to a candidate point of view for which a frequency calculated as the position information of the worker A is higher than or equal to a predetermined frequency, and the frequently searched candidate field-of-view direction corresponds to a candidate field-of-view direction for which a frequency calculated as the position information of the worker A is higher than or equal to a predetermined frequency. To perform the processing, area management information including the area name may be associated with the three-dimensional space information 181.

The processing device 101 prioritizes frequently searched point of views in a predetermined range in order and extracts the candidate point of views and the candidate field-of-view directions. The predetermined range includes a cube having a length X (m) centered on the frequently searched point of view, and the processing device 101 searches the cube. The processing device 101 uses a result of the search to extract the field-of-view image for each of the candidate field-of-view directions corresponding to the respective candidate points in the predetermined range. The extraction method can be implemented as described in the first and second specific examples of the process of extracting target three-dimensional space information. In the first specific example of the process of extracting target three-dimensional space information, the process is performed with priority according to the probability that the worker A is present based on past performance, and thus the field-of-view image can be efficiently extracted.

Lastly, in the second specific example of the process of extracting target three-dimensional space information, based on characteristics of the target area range, the candidate point of views and the candidate field-of-view directions are narrowed down and the field-of-view image is extracted. FIG. 7B is a diagram schematically illustrating a second specific example of a process of extracting the field-of-view image according to the first embodiment.

In FIG. 7B, white triangles indicate candidate point of views searched with high priority that are processed with priority. In FIG. 7B, black circles indicate non-prioritized candidate point of views. Arrows illustrated in an upper part of FIG. 7B indicate lines of sight searched with high priority that are processed with priority. Therefore, in the three-dimensional space information 181 or the area information 182, whether each candidate point of view is a candidate point of view searched with high priority and whether each candidate field-of-view direction is a candidate field-of-view direction searched with high priority are recorded.

The processing device 101 prioritizes the point of view searched with high priority, and the field-of-view searched with high priority in order and extracts the candidate point of views and the candidate field-of-view directions. The processing device 101 uses results of the extraction to extract the field-of-view image for each of the candidate field-of-view directions corresponding to the respective candidate points in the predetermined range. In the second specific example, the field-of-view image can be efficiently extracted by performing processing from a position to be prioritized.

At least two of the first and second specific examples of the process of extracting target three-dimensional information and the first and second specific examples of the process of extracting the field-of-view image may be combined and performed. For example, the first or second specific example of the process of extracting the field-of-view image may be performed on an area narrowed down in the second specific example of the process of extracting target three-dimensional space information.

In each of the specific examples, the processing device 101 extracts the field-of-view image based on a predetermined condition by narrowing down the target three-dimensional space information or the candidate point of views and the candidate field-of-view directions. This narrowing down is not limited to each of the specific examples.

In the second specific example, the point of view searched with high priority and the field-of-view searched with high priority are used, but at least one of the point of view searched with high priority and the field-of-view searched with high priority may be used. For example, the point of view searched with high priority may be used.

According to the embodiment and the first embodiment, since a location (for example, coordinates) and a field-of-view direction are acquired as the position information of the target who is the worker A, it is possible to support work in response to an unforeseen event. The present invention is not limited to the embodiment and the first embodiment. The present invention is applicable not only to the work support but also to navigation and guidance systems including car navigation, control of movement of mobile objects, monitoring of the flow of people, measures to prevent people from getting lost, and the like. These applications are particularly suitable for indoor use. The present invention is applicable to maintenance of infrastructure, such as building security, power plants, water and sewerage systems. The work can be applied not only to production but also to maintenance such as repairs and cleaning. The target of the present invention includes not only a worker but also various devices such as self-propelled robots, industrial robots, automobiles, railway vehicles, and other vehicles.

### REFERENCE SIGNS LIST

1: work support device, 11: input and output unit, 12: data acquisition unit, 13: target area identification unit, 14: auxiliary storage device, 15: line-of-image extraction unit, 16: position estimation unit, 17: work support information generation unit, 18: storage unit, 181: three-dimensional space information, 182: area information, 183: worker management information, 184: knowledge information, 2: worker terminal, 21: communication unit, 22: input unit, 23: output unit, 24: imaging unit, 25: work support instruction unit, 26: storage unit, 3: network

What is claimed is:

1. A position estimation device that estimates a position of a target, the position estimation device comprising:
a data acquisition unit that acquires an production-site floor image captured by a device worn by the target;
a field-of-view image extraction unit that extracts a field-of-view image virtually indicating a field of view of the target and corresponding to field-of-view information of the target based on target area three-dimensional space information that is three-dimensional space information of a target area range where the target is present; and
a position estimation unit that calculates position information indicating the position of the target by comparing the field-of-view image with the captured production-site floor image.

2. A position estimation device that estimates a position of a target, the position estimation device comprising:
a data acquisition unit that acquires an production-site floor image captured by a device worn by the target, and input data from the target;
a target area identification unit that identifies, based on the input data, area information of a target area range where the target is present;
a three-dimensional space information identification unit that identifies, based on the area information, target area three-dimensional space information that is three-dimensional space information of the target area range;
a field-of-view image extraction unit that extracts a field-of-view image virtually indicating a field of view of the target and corresponding to field-of-view information of the target based on the target area three-dimensional space information; and
a position estimation unit that calculates the position information indicating the position of the target by comparing the field-of-view image with the captured production-site floor image.

3. The position estimation device according to claim 2, wherein
the field-of-view information of the target includes a point of view and/or a field-of-view direction of the target.

4. The position estimation device according to claim 2, further comprising
a storage unit that stores the three-dimensional space information divided into a plurality of areas, wherein
the three-dimensional space information identification unit narrows down the plurality of areas to an area corresponding to the target area range, and extracts three-dimensional space information of the narrowed down area as target three-dimensional space information from the three-dimensional space information.

5. The position estimation device according to claim 2, wherein
the field-of-view image extraction unit extracts a candidate point of view and a candidate field-of-view direction in a priority order based on a history indicating a frequency calculated as the position information, and extracts the field-of-view image using the extracted candidate point of view and the extracted candidate field-of-view direction.

6. The position estimation device according to claim 2, wherein
the field-of-view image extraction unit extracts a candidate point of view and a candidate field-of-view direction in a priority order based on a characteristic of the target area range, and extracts the field-of-view image using the extracted candidate point of view and the extracted candidate field-of-view direction.

7. The position estimation device according to claim 2, wherein
the target area identification unit identifies the area information in a case where the input data includes question information.

8. The position estimation device according to claim 7, wherein
the target area identification unit identifies the area information in a case where the question information is audio data.

9. A work support device that is the position estimation device according to claim 2 and performs work support for the target, the work support device further comprising:
a storage unit that stores knowledge information for performing the work support;
a work support information generation unit that generates work support information using the position information and the knowledge information; and
an output unit that outputs the work support information.

10. A storage medium storing a position estimation program causing a position estimation device that is a computer and estimates a position of a target to function as:
a data acquisition unit that acquires an production-site floor image captured by a device worn by the target;
a field-of-view image extraction unit that extracts a field-of-view image virtually indicating a field of view of the target and corresponding to field-of-view information of the target based on target area three-dimensional space information that is three-dimensional space information of a target area range where the target is present; and
a position estimation unit that calculates the position information indicating the position of the target by comparing the field-of-view image with the captured production-site floor image.

11. A storage medium storing a position estimation program causing a position estimation device that is a computer and estimates a position of a target to function as:
a data acquisition unit that acquires an production-site floor image captured by a device worn by the target, and input data from the target;
a target area identification unit that identifies, based on the input data, area information of a target area range where the target is present;
a three-dimensional space information identification unit that identifies, based on the area information, target area three-dimensional space information that is three-dimensional space information of the target area range;
a field-of-view image extraction unit that extracts a field-of-view image virtually indicating a field of view of the target and corresponding to field-of-view information of the target based on the target area three-dimensional space information; and
a position estimation unit that calculates the position information indicating the position of the target by comparing the field-of-view image with the captured production-site floor image.

12. The storage medium according to claim 11, wherein
the field-of-view information of the target includes a point of view and/or a field-of-view direction of the target.

13. The storage medium according to claim 11,
the position estimation program further causing the position estimation device to function as a storage unit that stores the three-dimensional space information divided into a plurality of areas, wherein
the three-dimensional space information identification unit narrows down the plurality of areas to an area corresponding to the target area range, and extracts three-dimensional space information of the narrowed down area as target three-dimensional space information from the three-dimensional space information.

14. The storage medium according to claim 11, wherein
the field-of-view image extraction unit extracts a candidate point of view and a candidate field-of-view direction in a priority order based on a history indicating a frequency calculated as the position information, and extracts the field-of-view image using the extracted candidate point of view and the extracted candidate field-of-view direction.

15. The storage medium according to claim 11, wherein
the field-of-view image extraction unit extracts a candidate point of view and a candidate field-of-view direction in a priority order based on a characteristic of the target area range, and extracts the field-of-view image using the extracted candidate point of view and the extracted candidate field-of-view direction.

16. The storage medium according to claim 11, wherein
the target area identification unit identifies the area information in a case where the input data includes question information.

17. The storage medium according to claim 16, wherein
the target area identification unit identifies the area information in a case where the question information is audio data.

18. A storage medium storing a work support program causing a work support device that is the position estimation device according to claim 11 and performs work support for the target to further function as:
a storage unit that stores knowledge information for performing the work support;
a work support information generation unit that generates work support information using the position information and the knowledge information; and
an output unit that outputs the work support information.
